(19) United States
(12) Patent Application Publication
(10) Pub. No.: US 2026/0266091 A1
(43) Pub. Date: Sep. 10, 2026

(54) LOCK DEVICE AND SYSTEM

(71) Applicant: ASSA ABLOY AB, Stockholm (SE)

(72) Inventor: Erik Holst-Larsen, Oslo (NO)

(21) Appl. No.: 18/873,522

(22) PCT Filed: Jun. 1, 2023
(86) PCT No.: PCT/EP2023/064709

§ 371 Date: Dec. 10, 2024

(30) Foreign Application Priority Data
Jun. 17, 2022 (SE) 2250737-0

(51) Int. Cl. E05B 9/00; E05B 63/08

(52) U.S. Cl. CPC E05B 9/002; E05B 63/08

(57) ABSTRACT

A lock device (22) for installation in an access member (12), the lock device comprising a lock case (28); a forend (30); an adjustment screw (40, 42) passing through the forend and threadingly engaging the lock case, the adjustment screw being manipulatable between an adjustment position (66) where the forend is allowed to move relative to the lock case and where the adjustment screw prevents removal of the forend from the lock case, and a secured position (48) where the forend is secured to the lock case by the adjustment screw; and at least one locking element (44a, 44b, 46a, 46b) allowing the adjustment screw to be adjusted between the adjustment position and the secured position, and preventing the adjustment screw from being removed from the lock case. A system (10) comprising a lock device (22) and an access member (12) is also provided.

### TECHNICAL FIELD

The present disclosure generally relates to lock devices. In particular, a lock device for installation in an access member and a system comprising a lock device and an access member, are provided.

### BACKGROUND

A lock device comprising a retractable bolt may be installed in a pocket in a door leaf. The lock device may comprise a lock case and a forend. The bolt may adopt an extended position passing through the forend and engaging a strike in a frame.

Some lock devices comprise a rotatable forend. The forend can then be adjusted to be flush with an end surface of the door leaf. One reason for the need to make such adjustment is that the end surface may be slightly angled, such as five degrees, to a plane perpendicular to an outer side surface and an inner side surface of the door leaf.

US 2016305161 A1 discloses a lock comprising a housing, a faceplate and a tab. The faceplate is rotatable and comprises a protrusion. Tab has openings for receiving screws to connect the faceplate to the housing.

### SUMMARY

In US 2016305161 A1, the screws are not accessible when the lock is installed in a door leaf. The faceplate therefore has to be adjusted when the lock is removed from the door leaf. This makes adjustments of the faceplate complicated and less accurate.

One object of the invention is to provide an improved lock device for installation in an access member.

A further object of the invention is to provide an improved system comprising a lock device and an access member.

These objects are achieved by the lock device according to appended claim 1 and the system according to appended claim 10.

The invention is based on the realization that by providing a lock device comprising a locking element preventing removal of an adjustment screw passing through a forend but allowing the adjustment screw to be manipulated between an adjustment position and a secured position, the lock device enables adjustment of the forend relative to a lock case after installation of the lock case in an access member while at the same time preventing unauthorized removal of the forend.

According to a first aspect, there is provided a lock device for installation in an access member, the lock device comprising a lock case; a forend; an adjustment screw passing through the forend and threadingly engaging the lock case, the adjustment screw being manipulatable between an adjustment position where the forend is allowed to move relative to the lock case and where the adjustment screw prevents removal of the forend from the lock case, and a secured position where the forend is secured to the lock case by the adjustment screw; and at least one locking element allowing the adjustment screw to be adjusted between the adjustment position and the secured position, and preventing the adjustment screw from being removed from the lock case.

When the lock device is installed in the access member, a user can screw the adjustment screw from the secured position to the adjustment position, e.g. by loosening the adjustment screw using a screwdriver. When the adjustment screw is in the adjustment position, the user may move the forend relative to the lock case, e.g. by manually pushing or pulling the forend. At the same time, a cooperation between the adjustment screw and the at least one locking element, such as an engagement therebetween, prevents complete removal of the adjustment screw from the forend. Once the forend is in a desired position, the user can screw the adjustment screw from the adjustment position back to the secured position, e.g. by tightening the adjustment screw using the screwdriver. The forend is thereby secured in the desired position. In each of the secured position and the adjustment position, the at least one locking element prevents the adjustment screw, and consequently the forend, from being removed from the lock case. The lock device thus enables easy adjustment of the forend relative to the lock case after installation of the lock device in the access member without compromising security.

Throughout the present disclosure, the access member may be a door leaf or a window. In any case, the access member may be rotatable relative to a frame. The access member may comprise an outer side surface and a inner side surface parallel with the outer side surface. When the adjustment screw adopts the adjustment position, the forend may be adjusted to or from a neutral position where a front surface thereof is perpendicular to each of the outer side surface and the inner side surface. The forend may be a faceplate. The adjustment screw and the at least one locking element may form a set.

The lock device may comprise a plurality of such sets. For example, the lock device may comprise a first set including a primary adjustment screw and at least one primary locking element cooperating with the primary adjustment screw, and a second set including a secondary adjustment screw and at least one secondary locking element cooperating with the secondary adjustment screw.

The forend may comprise a tapered through hole. The through hole may comprise a wide portion and a narrow portion. The wide portion may be positioned between the at least one locking element and the narrow portion.

Each of the at least one locking element may be a locking screw threadingly engaging the lock case.

The adjustment screw may comprise a waist. In this case, each of the at least one locking element may engage the waist. When the adjustment screw moves between the secured position and the adjustment position, the at least one locking element may travel along the waist. The waist may be an annular recess in the adjustment screw.

Each of the at least one locking element may comprise a locking tip. In this case, each locking tip may engage the waist. The locking tip may engage the waist in each of the secured position and the adjustment position of the adjustment screw.

The adjustment screw may comprise a ball-shaped head and the forend may comprise a concave profile. In this case, the ball-shaped head may be seated in the concave profile when the adjustment screw adopts the secured position.

The forend may comprise a front surface. In this case, the lock case may comprise a wall transverse to the front surface in at least one position of the forend relative to the lock case, such as in the neutral position thereof. The at least one locking element may pass through the wall.

Each locking element may be elongated. In this case, each locking element may be oriented substantially parallel with, or parallel with, the front surface in at least one position of the forend relative to the lock case, such as in the neutral position thereof.

The forend may be allowed to rotate relative to the lock case about a rotation axis when the adjustment screw adopts the adjustment position.

The rotation axis may pass through the forend. In this way, an angle of the forend with respect to the lock case can be adjusted with minimal lateral movements of the forend relative to the lock case. This reduces a risk of interference between the forend and any moving parts moving through the forend, such as a bolt. In addition, any openings through the forend can be made smaller. A more compact design is therefore enabled.

The lock device may further comprise a cradle bearing rotationally supporting the forend relative to the lock case. The cradle bearing may comprise a seat fixed to the lock case and a convex profile fixed to the front surface. The seat may have a seat profile matching the convex profile. The convex profile may be arranged to slidingly engage the seat.

The forend may be allowed to rotate at least 3 degrees in two directions about the rotation axis from a neutral position.

According to a second aspect, there is provided a system comprising a lock device according to the first aspect and an access member. In this case, the lock case may be received in the access member. The access member may for example be a door leaf or a window.

The at least one locking element may be located inside the access member.

### BRIEF DESCRIPTION OF THE DRAWINGS

Further details, advantages and aspects of the present disclosure will become apparent from the following description taken in conjunction with the drawings, wherein:

FIG. 1: schematically represents a front view of a system comprising an access member and a lock device;

FIG. 2: schematically represents a rear view of the system;

FIG. 3: schematically represents a front perspective view of the lock device;

FIG. 4: schematically represents a rear perspective view of the lock device;

FIG. 5: schematically represents a cross-sectional top view of the lock device;

FIG. 6: schematically represents a partial cross-sectional top view of the lock device when an adjustment screw is in a secured position; and

FIG. 7: schematically represents a partial cross-sectional top view of the lock device when the adjustment screw is in an adjustment position.

### DETAILED DESCRIPTION

In the following, a lock device for installation in an access member and a system comprising a lock device and an access member, will be described. The same or similar reference numerals will be used to denote the same or similar structural features.

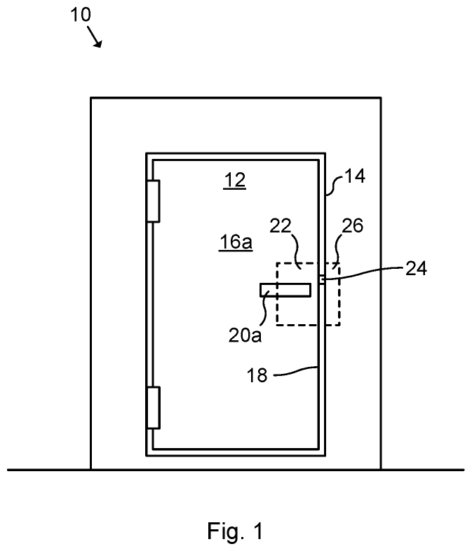

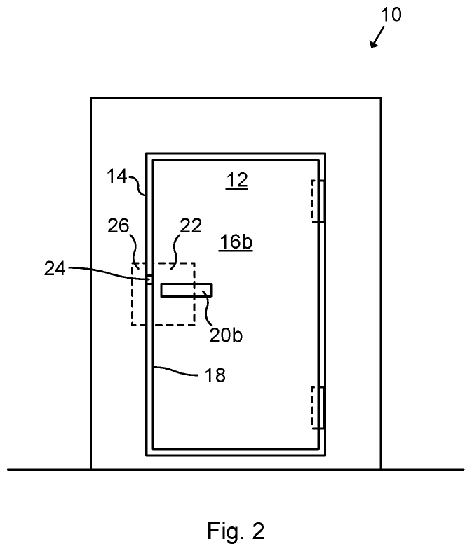

FIG. 1 schematically represents a front view of a system 10 and FIG. 2 schematically represents a rear view of the system 10. With collective reference to FIGS. 1 and 2, the system 10 comprises a door leaf 12 and a frame 14. The door leaf 12 is rotatable relative to the frame 14. In FIGS. 1 and 2, the door leaf 12 is in a closed position. The door leaf 12 is one example of an access member according to the present disclosure.

The door leaf 12 of this example comprises an outer side surface 16a and an inner side surface 16b, parallel with the outer side surface 16a. The outer side surface 16a and the inner side surface 16b are here vertical. The door leaf 12 of this example further comprises an end surface 18. The end surface 18 is perpendicular to each of the outer side surface 16a and the inner side surface 16b. In this specific and non-limiting example, an outer handle 20a is arranged on the outer side surface 16a and an inner handle 20b is arranged on the inner side surface 16b.

The system 10 further comprises a lock device 22. The lock device 22 is installed in a pocket in the door leaf 12. The lock device 22 of this example comprises a bolt 24. In FIGS. 1 and 2, the bolt 24 is in an extended position engaging a strike 26 in the frame 14. The bolt 24 is movable from the extended position to a retracted position by manual actuation of any of the handles 20a, 20b.

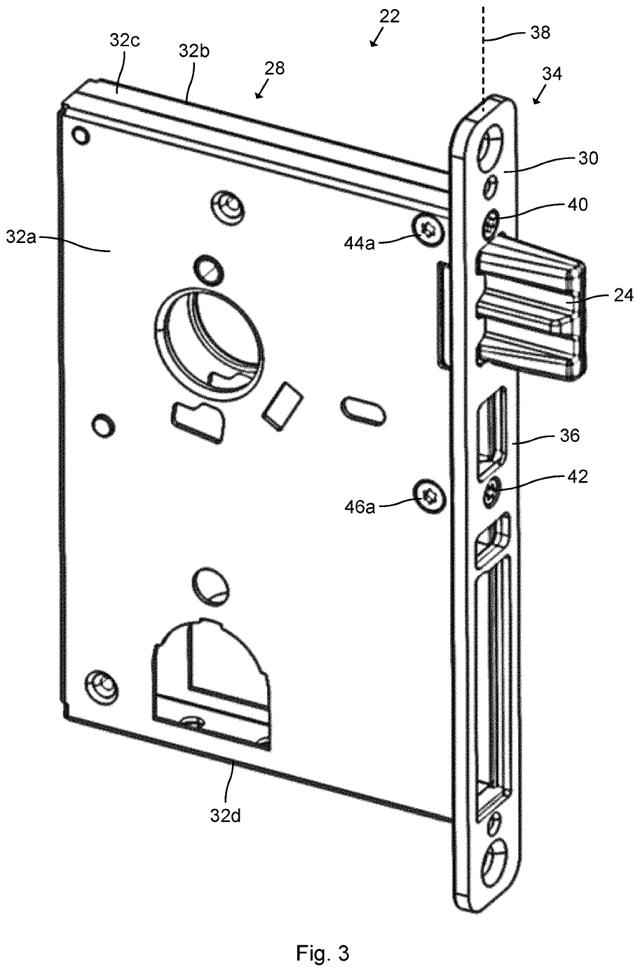

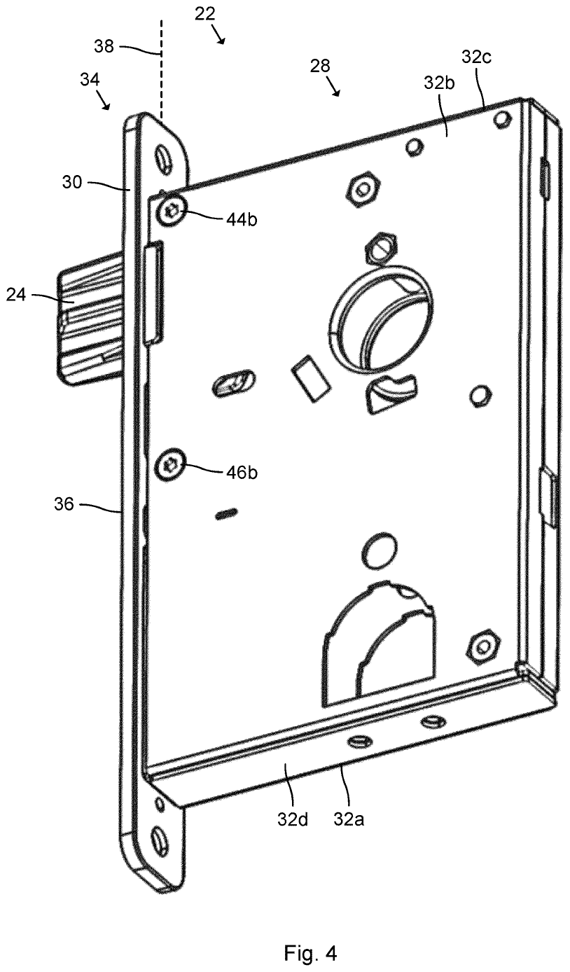

FIG. 3 schematically represents a front perspective view of the lock device 22 and FIG. 4 schematically represents a rear perspective view of the lock device 22. With collective reference to FIGS. 3 and 4, the lock device 22 comprises a lock case 28 and a forend 30. In the illustrated extended position, the bolt 24 passes through the forend 30.

The lock case 28 of this example comprises two vertical walls 32a, 32b and two horizontal walls 32c, 32d. In FIGS. 3 and 4, the forend 30 is in a neutral position 34. In the neutral position 34, a front surface 36 of the forend 30 is perpendicular to each of the walls 32a-32d. The forend 30 can be rotated relative to the lock case 28 about a rotation axis 38 as described herein. In this implementation, the rotation axis 38 is vertically oriented.

The lock device 22 of this example comprises two adjustment screws 40, 42. The lock device 22 of this example further comprises two locking screws 44a, 44b associated with the adjustment screw 40 and two locking screws 46a, 46b associated with the adjustment screw 42. The adjustment screw 40 and the locking screws 44a, 44b form a first set. The adjustment screw 42 and the locking screws 46a, 46b form a second set. In this example, a function of the first set is identic to a function of the second set. Moreover, a design of the adjustment screw 40 and the locking screws 44a, 44b is identic to a design of the adjustment screw 42 and the locking screws 46a, 46b. Thus, any reference to the first set applies equally to the second set and vice versa. Descriptions of the adjustment screw 40 and the locking screws 44a, 44b are not always repeated herein for the adjustment screw 42 and the locking screws 46a, 46b. The locking screws 44a, 44b, 46a, 46b are examples of locking elements according to the present disclosure. The lock device 22 may comprise more than two such sets or only one such set.

The adjustment screws 40, 42 pass through the forend 30 and are accessible from the front surface 36. The locking screws 44a, 44b, 46a, 46b on the other hand are located inside door leaf 12 when the lock device 22 is installed in the door leaf 12 and are therefore hidden from access. The locking screws 44a, 46a pass through the wall 32a and the locking screws 44b, 46b pass through the wall 32b. As an alternative or addition to the locking screws 44a, 44b, one locking screw may be used that passes through the wall 32c.

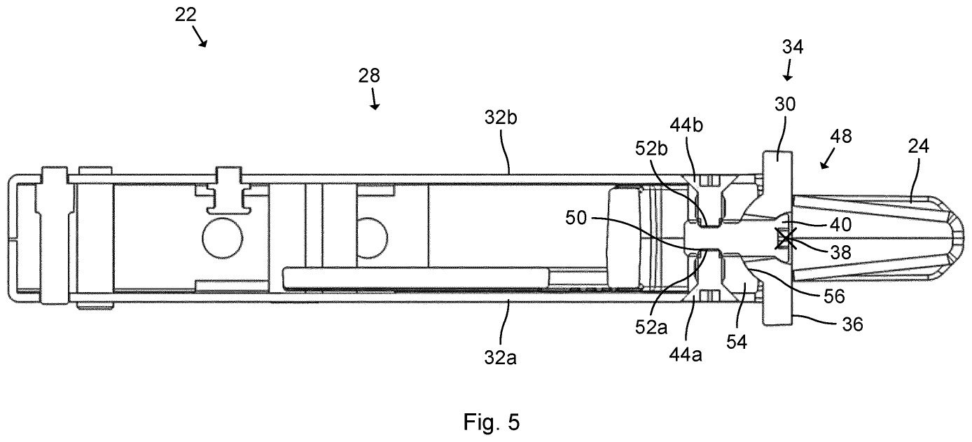

FIG. 5 schematically represents a cross-sectional top view of the lock device 22. In FIG. 5, the adjustment screw 40 is in a secured position 48. In the secured position 48, the forend 30 is secured to the lock case 28 by the adjustment screw 40. The forend 30 is therefore prevented from rotating about the rotation axis 38.

As shown, the adjustment screw 42 comprises a waist 50, the locking screw 44a comprises a locking tip 52a and the locking screw 44b comprises a locking tip 52b. The waist 50 is here an annular recess in the adjustment screw 42. Each locking tip 52a, 52b engages the waist 50. The locking screws 44a, 44b thereby serve as an anchor for the adjustment screw 42. Since the locking screws 44a, 44b are positioned through the walls 32a, 32b of the lock case 28 that are not accessible from the exterior of the door leaf 12, tampering of the locking screws 44a, 44b is prevented.

The lock case 28 of this example comprises a seat 54. The seat 54 is fixed to the walls 32a, 32b, for example by means of the locking screws 44a, 44b. The forend 30 comprises a convex profile 56. The seat 54 has a seat profile matching the convex profile 56. The seat 54 and the convex profile 56 form one example of a cradle bearing according to the present disclosure.

The illustrated convex profile 56 is in this example a primary convex profile associated with the adjustment screw 40 and the locking screws 44a, 44b. The lock device 22 of this example also comprises a secondary cradle bearing (not shown) of the same type associated with the adjustment screw 42 and the locking screws 46a, 46b.

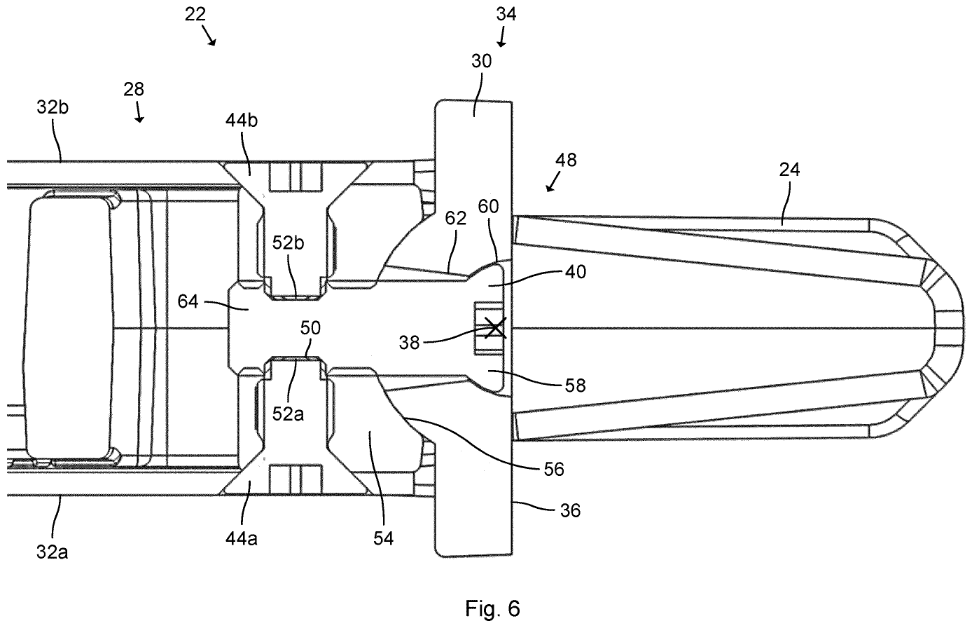

FIG. 6 schematically represents a partial cross-sectional top view of the lock device 22. In the secured position 48, the adjustment screw 40 threadingly engages the lock case 28. In this specific example, the adjustment screw 40 threadingly engages an internal thread (not denoted) in the seat 54. As shown in FIG. 6, the rotation axis 38 passes through the forend 30.

FIG. 6 further shows that the adjustment screw 40 of this example comprises a ball-shaped head 58 and the forend 30 of this example comprises a concave profile 60. The ball-shaped head 58 is of a shape matching the concave profile 60. In the secured position 48, the ball-shaped head 58 is seated in the concave profile 60.

FIG. 6 further shows that the forend 30 comprises a tapered through hole 62. The through hole 62 comprises a wide portion towards the locking screws 44a, 44b and a narrow portion towards the front surface 36.

FIG. 6 further shows that the adjustment screw 40 of this example comprises a screw tip 64. The screw tip 64 is threaded. The waist 50 is positioned between the screw tip 64 and the ball-shaped head 58.

FIG. 6 further shows that each locking screw 44a, 44b is elongated and parallel with the front surface 36 in the illustrated neutral position 34 of the forend 30.

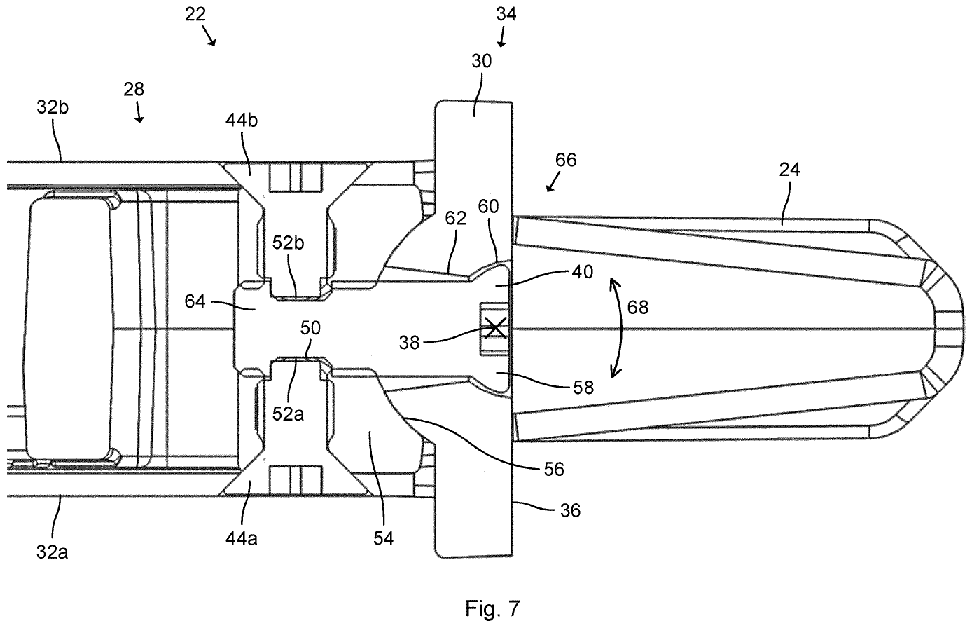

FIG. 7 schematically represents a partial cross-sectional top view of the lock device 22. In FIG. 7, the adjustment screw 40 is in an adjustment position 66. Also in the adjustment position 66, the adjustment screw 40 threadingly engages the lock case 28, here by threadingly engaging the seat 54.

The adjustment screw 40 can be screwed between the secured position 48 and the adjustment position 66 by using a screwdriver. When the adjustment screw 40 moves between the secured position 48 and the adjustment position 66, the locking tips 52a, 52b travel in the waist 50. The locking screws 44a, 44b thus engage the waist 50 in each of the secured position 48 and the adjustment position 66. The adjustment screw 40 is thereby secured to the forend 30 in each of the secured position 48 and the adjustment position 66. Thus, despite the adjustment screw 40 is accessible through the forend 30, the adjustment screw 40 is prevented from being removed from the forend 30.

In the adjustment position 66, the forend 30 is allowed to be rotated relative to the end surface 18 and the lock case 28 about the rotation axis 38 as shown with arrow 68. The forend 30 may for example be rotated at least 5 degrees in a clockwise direction (in FIG. 7) about the rotation axis 38 from the neutral position 34, and at least 5 degrees in a counterclockwise direction (in FIG. 7) about the rotation axis 38 from the neutral position 34. Since the rotation axis 38 passes through the forend 30, sideways movements of the forend 30 are minimized during rotation of the forend 30 about the rotation axis 38.

The tapering of the through hole 62 allows rotation of the forend 30 without interference with the adjustment screw 40. During rotation of the forend 30, the convex profile 56 is slidingly supported against the seat 54. Since the waist 50 is relatively short, the adjustment screw 40 can only be loosened to a degree necessary to rotate the forend 30.

Once the forend 30 has been positioned in a desired position relative to the lock case 28 and the door leaf 12, the adjustment screw 40 is tightened such that the adjustment screw 40 moves from the adjustment position 66 back to the secured position 48. The position of the forend 30 can thus easily be adjusted after installation of the lock device 22 in the door leaf 12 without compromising security.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1-12. (canceled)

13. A lock device for installation in an access member, the lock device comprising:
a lock case;
a forend;
an adjustment screw passing through the forend and threadingly engaging the lock case, the adjustment screw being manually manipulatable between an adjustment position, where the forend is allowed to move relative to the lock case and where the adjustment screw prevents removal of the forend from the lock case, and a secured position, where the forend is secured to the lock case by the adjustment screw; and
at least one locking element allowing the adjustment screw to be adjusted between the adjustment position and the secured position and preventing the adjustment screw from being removed from the lock case.

14. The lock device according to claim 13, wherein each of the at least one locking element is a locking screw threadingly engaging the lock case.

15. The lock device according to claim 13, wherein the adjustment screw comprises a waist, and wherein each of the at least one locking element engages the waist.

16. The lock device according to claim 15, wherein each of the at least one locking element comprises a locking tip, and wherein each locking tip engages the waist.

17. The lock device according to claim 13, wherein the adjustment screw comprises a ball-shaped head, wherein the forend comprises a concave profile, and wherein the ball-shaped head is seated in the concave profile when the adjustment screw adopts the secured position.

18. The lock device according to claim 13, wherein the forend comprises a front surface, wherein the lock case comprises a wall transverse to the front surface in at least one position of the forend relative to the lock case, and wherein the at least one locking element passes through the wall.

19. The lock device according to claim 13, wherein the forend is allowed to rotate relative to the lock case about a rotation axis when the adjustment screw adopts the adjustment position.

20. The lock device according to claim 19, wherein the rotation axis passes through the forend.

21. The lock device according to claim 19, further comprising a cradle bearing rotationally supporting the forend relative to the lock case.

22. The lock device according to claim 19, wherein the forend is allowed to rotate at least 3 degrees in two directions about the rotation axis from a neutral position.

23. A system comprising a lock device according to claim 13 and an access member, wherein the lock case is received in the access member.

24. The system according to claim 23, wherein the at least one locking element is located inside the access member.
